(19) United States
(12) Patent Application Publication
(10) Pub. No.: US 2024/0405606 A1
(43) Pub. Date: Dec. 5, 2024

(54) LONG RANGE WIRELESS CHARGING SYSTEM AND CHARGING METHOD FOR VEHICLE

(71) Applicant: DAEWONSANUP CO., LTD., Ansan-si (KR)

(72) Inventors: Hyuk KIM, Ansan-si (KR); Won Ho CHANG, Cheonan-si (KR); Dong Jun LEE, Cheonan-si (KR); Han Jin KIM, Suwon-si (KR)

(73) Assignee: DAEWONSANUP CO., LTD., Ansan-si (KR)

(21) Appl. No.: 18/669,743

(22) Filed: May 21, 2024

(30) Foreign Application Priority Data
Jun. 1, 2023 (KR) 10-2023-0070985

(51) Int. Cl. H02J 50/00; B60N 2/07; B60N 2/80; B60N 2/879; B60R 16/03; B60R 16/04; H02J 7/00; H02J 50/40; H02J 50/60; H02J 50/80

(52) U.S. Cl. CPC H02J 50/005; B60N 2/0742; B60N 2/879; B60R 16/03; B60R 16/04; H02J 7/00034; H02J 7/0042; H02J 50/40; H02J 50/60; H02J 50/80; B60N 2002/899; B60N 2230/20; H02J 7/0013; H02J 2310/40

(57) ABSTRACT

The present disclosure relates to a long range wireless charging system for vehicle, and may include a wireless charging module including a power transmitting unit installed on one side of a vehicle body which transmits a wireless power signal and a seat power receiving unit installed on one side of a seat, which receives the wireless power signal from the power transmitting unit.

### CROSS-REFERENCE TO RELATED APPLICATION(S)

The present application claims priority under 35 U.S.C. § 119 (a) to Korean Patent Application No. 10-2023-0070985, filed on Jun. 1, 2023, in the Korean Intellectual Property Office, the entire contents of which application is hereby incorporated by reference.

### STATEMENT REGARDING SPONSORED RESEARCH OR DEVELOPMENT

The research and development of the present invention were conducted with the support of the Korea Institute of Advancement of Technology (KIAT) with the financial resources of the Ministry of Trade, Industry and Energy (MOTIE) from the World Class Plus Program (Project Number: P0021941, Detailed Project identifier: 1415189597).

### TECHNICAL FIELD

The present disclosure relates to a wireless charging system, and more specifically to a long range wireless charging system and a charging method for vehicle for wirelessly charging various devices inside a vehicle.

### BACKGROUND

Since the emergence of autonomous driving technology, utilization of a seat in a vehicle interior space is increasing. In addition to the existing function of raising, lowering, moving forward and backward, and tilting of the seat to create a space for additional cargo or luggage, technologies utilizing the vehicle interior space are emerging which allow the seat to be positioned in various ways, such as in conference mode and theater mode using a swivel function.

### SUMMARY

According to one embodiment of the present disclosure, a long range wireless charging system for vehicle is provided. The long range wireless charging system for vehicle may include a wireless charging module comprising a power transmitting unit installed on one side of a vehicle body which transmits a wireless power signal; a seat power receiving unit installed on one side of a seat, which receives the wireless power signal from the power transmitting unit.

According to one embodiment of the present disclosure, a long range wireless charging method for vehicle is provided. The long range wireless charging method for vehicle may include a step (a) of measuring whether a charging amount of a seat battery installed inside a vehicle is less than a preset reference amount; a step (b) of transmitting a wireless power signal to the seat battery; a step (c) of detecting obstacles on a wireless power supply path and determining the type of the obstacle; and a step (d) of interrupting or continuing transmission of the wireless power signal according to the type of the determined obstacle.

### BRIEF DESCRIPTION OF DRAWINGS

FIG. 1 is a conceptual diagram schematically showing a long range wireless charging system for vehicle according to one embodiment of the present disclosure.

FIG. 2 is a perspective view schematically showing a headrest of the long range wireless charging system for vehicle according to one embodiment of the present invention.

FIG. 3 is a perspective view schematically showing a driving mode of the long range wireless charging system for vehicle according to one embodiment of the present disclosure in which a first row left seat and a first row right seat arranged in a front direction.

FIG. 4 is a perspective view schematically showing a conference mode of the long range wireless charging system for vehicle in which a first row left seat and a first row right seat of the long range wireless charging system for vehicle are arranged in a rearward direction.

FIG. 5 is a block diagram schematically showing the components of the long range wireless charging system for vehicle according to one embodiment of the present disclosure.

FIG. 6 is a flowchart sequentially showing a charging operation process of the long range wireless charging system for vehicle according to one embodiment of the present disclosure.

FIG. 7 is a flowchart sequentially showing a charging operation process of the long range wireless charging method for vehicle according to one embodiment of the present disclosure.

### DETAILED DESCRIPTION OF EXEMPLARY EMBODIMENTS

Hereinafter, the present disclosure will be described in detail by explaining embodiments of the present disclosure with reference to the attached drawings.

Various embodiments of the present disclosure may be embodied in many different forms and should not be construed as being limited to the example embodiments set forth herein. Rather, these example embodiments of the disclosure are provided so that this disclosure will be thorough and complete and will convey inventive concepts of the disclosure to those skilled in the art. Also, in the drawings, the thicknesses or sizes of layers are exaggerated for clarity.

Embodiments of the disclosure are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the disclosure should not be construed as limited to the particular shapes of regions illustrated herein, but are to include deviations in shapes that result, for example, from manufacturing.

With regard to the swiveling seat, a wire which supplies power to the seat has been experiencing twisting when the seat swivels or slides forward and backward over a large range. In order to solve this problem, technologies are being developed to supply power to the seat in a structure in which power is received through a contact from a bus bar installed on a long rail, or in a magnetic induction method using a power receiving coil installed in a position corresponding to a power transmitting coil.

However, pogo pins are applied to the bus bar contact-type power supply structure described above so that they are always in contact with the bus bar, which causes frictional wear when the seat slides forward and backward, resulting in a problem in which the power was not supplied flawlessly. In the case of the magnetic induction method, if the power transmitting coil and the power receiving coil are not thoroughly aligned, or if the two coils are not close enough to each other, the power supply efficiency decreased rapidly.

The present disclosure is intended to solve various problems including the above problems and aims to provide a long range wireless charging system for vehicle in which a seat can freely drive forward, backward, and swivel by wirelessly powering the seat from a long range. However, these problems are exemplary and do not limit the scope of the present disclosure.

According to an embodiment of the present disclosure having the above configuration, it is possible to provide a wireless power supply using infrared wave, ultrasound wave, electromagnetic wave, laser, and the like, so even when a seat is swiveling or sliding forward and backward, the seat can be driven freely without twisting the wires.

Further, a seat power receiving unit which receives a wireless power signal can be installed on left or right side of a seat headrest, allowing transmission and reception of the wireless power signal in a path which does not interfere with a seated passenger even when the seat is swiveled. Furthermore, when an object is detected on the power supply path and the object is determined to be a human body, the power supply can be interrupted, ensuring passenger safety. Additionally, if the object is detected to be a thing, the power supply can be continued to prevent charging efficiency from decreasing.

Moreover, a mobile device charger which receives power wirelessly, has the effect of allowing various mobile devices to be freely used while wirelessly charging them over a long distance in a vehicle interior space. However, the scope of the present invention is not limited by these effects.

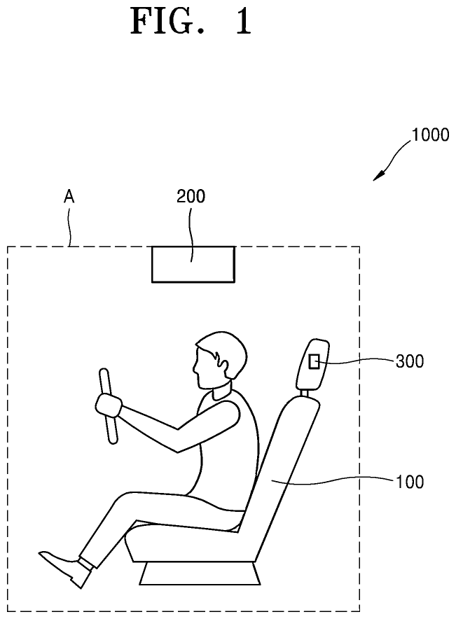

FIG. 1 is a conceptual diagram schematically showing a long range wireless charging system for vehicle 1000 according to one embodiment of the present disclosure.

As illustrated in FIG. 1, the long range wireless charging system for vehicle 1000 may include a wireless charging module 200 installed on one side of a vehicle body A, and a seat power receiving unit 300 installed on one side of a seat 100 which receives a wireless power signal from the wireless charging module 200. Here, the wireless charging module 200 can supply power to the seat power receiving unit 300 wirelessly using at least one of infrared wave, ultrasound wave, electromagnetic wave, and laser.

Here, the seat power receiving unit 300 is installed on a ceiling of the vehicle body and is installed in a position corresponding to a center of an interior space of the vehicle.

Therefore, the wireless charging module 200 of the present disclosure solves the problem of a magnetic induction method in which the charging efficiency decreases rapidly as the alignment of a transmission coil and a receiving coil is misaligned or as the distance between them increases.

Accordingly, fully autonomous movement of the seat inside the vehicle can be achieved, and the power can be supplied in a path which avoids interference from a human body.

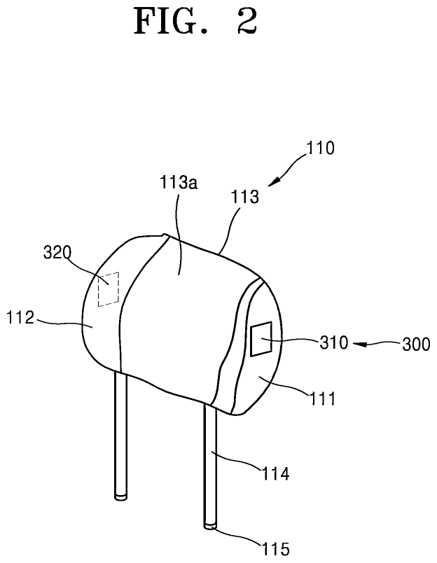

Further, as shown in FIG. 2, the headrest 110 of the seat 100 may include a central head supporting part 113 including at least a portion of a support surface 113a supporting a human head, a left head supporting part 111 installed on left side of the central head supporting part 113 with respect to a human body seated on the seat 100, formed to protrude by a predetermined distance in a front direction from the support surface 113a of the central head supporting part 113, and a right head supporting part 112 installed on right side of the central head supporting part 113 with respect to a human body seated on the seat 100, formed to protrude by a distance corresponding to the left head supporting part 111.

Thus, a passenger seated in the seat 100 can lean his/her head against the support surface 113a of the central head supporting part 113, and his/her head can be supported by the left head supporting part 111 and the right head supporting part 112 to prevent from being thrust to left or right. Such headrest 110 of the present disclosure may be formed in an overall U-shape, or the left head supporting part 111, the right head supporting part 112, and the central head supporting part 113 may be formed in an overall concave shape.

Further, the headrest 110 according to one embodiment of the present disclosure may include a pair of fixing poles 114 coupled to a backrest of the seat 100 by sliding and having a connector 115 formed on at least a portion thereof. Here, the connector 115 may be formed to correspond to, or to protrude further than an outer peripheral surface of the fixing pole 114 so as to maintain an electrical connection with the seat 100 when the headrest 110 is raised and lowered. In FIG. 2, the connector 115 is shown as being formed at an end of the fixing pole 114, but it can be formed in various shapes and positions capable of maintaining the electrical connection with the seat 100 when the headrest 110 is raised and lowered.

Here, the seat power receiving unit 300 may include at least one power receiving unit among a left power receiving unit 310 installed on the left head supporting part 111 and a right power receiving unit 320 installed on the right head supporting part 112. For example, the seat power receiving unit 300 may be installed only on the left head supporting part 111 of the headrest 110, only on the right head supporting part 112, or on both the left head supporting part 111 and the right head supporting part 112.

Further, the seat power receiving unit 300 may be integrally formed with the headrest 110 or removably coupled with the headrest 110 to facilitate repair or replacement due to a failure.

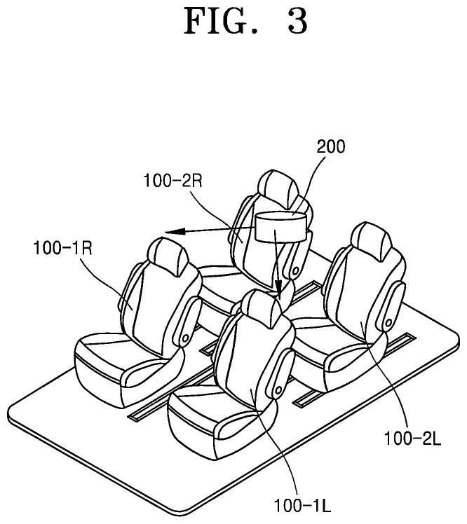

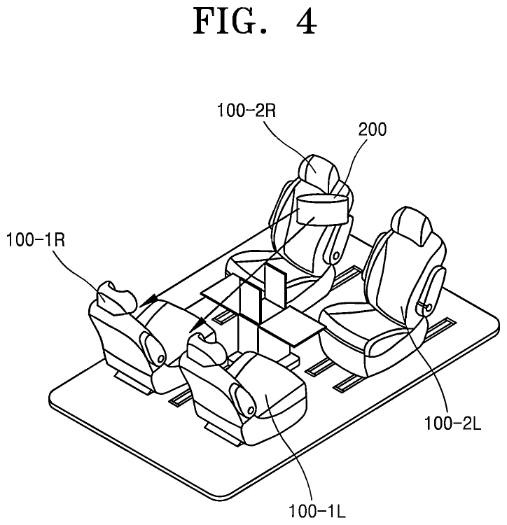

Hereinafter, with reference to FIGS. 3 and 4, various embodiments of the seat power receiving unit 300 of the long range wireless charging system for vehicle 1000 according to one embodiment of the present disclosure will be described.

According to one embodiment of the present disclosure, the seat power receiving unit 300 can be installed only on the left head supporting part 111 or only on the right head supporting part 112 of the headrest 110. For example, the seat power receiving unit 300 of a first row left seat 100-1L is a left power receiving unit 310 which can only be installed on the left head supporting part 111, and the seat power receiving unit 300 of a first row right seat 100-1R is a right power receiving unit 320 which can only be installed on the right head supporting part 112.

Thus, as shown in FIG. 3, in an arrangement in which the first row left seat 100-1L is facing forward, a head of a passenger seated in the first row left seat 100-1L is not positioned in a power supply path between the wireless charging module 200 installed on center of a ceiling of a vehicle body and the left power receiving unit 310 of the first row left seat 100-1L, thereby avoiding interference.

Further, as shown in FIG. 4, even in an arrangement in which the first row left seat 100-1L is swiveled counterclockwise to face rearward, the head of the passenger seated in the first row left seat 100-1L is not positioned in a power supply path between the wireless charging module 200 installed on the center of the ceiling of the vehicle body and the left power receiving unit 310 of the first row left seat 100-1L, thereby avoiding interference.

Even if the right power receiving unit 320 of a first row right seat (100-1R) is swiveled clockwise and positioned to face rearward, the head of the passenger seated in the first row right seat 100-1R is not positioned in a power supply path between the wireless charging module 200 and the right power receiving unit 320 of the first row right seat 100-1R, thereby avoiding interference.

As another embodiment of the present invention, if it is desired to reverse a reference swivel direction to avoid interference with a power supply of the first row left seat 100-1L and first row right seat 100-1R respectively, a seat power receiving unit 300 of the first row left seat 100-1L can be installed as a right power receiving unit 320 and only on the right head supporting part 112, and a seat power receiving unit 300 of the first row right seat 100-1R can be installed as a left power receiving unit 310 and only on the left head supporting part 111.

However, if the first row left seat 100-1L is swiveled clockwise or the first row right seat 100-1R is swiveled counterclockwise to face rearward, the passenger's head may be positioned in the power supply path.

Hence, according to another embodiment of the present disclosure, a seat power receiving unit 300 may include both a left power receiving unit 310 and a right power receiving unit 320. Therefore, for example, when supplying power to the left power receiving unit 310 of the first row left seat 100-1L and a passenger's head is positioned in the power supply path during the clockwise swivel, the power supply to the left power receiving unit 310 is interrupted and the power can be supplied to the right power receiving unit 320.

The embodiments described above are based on the left and right seats positioned in the first row, and the same can be applied to left and right seats positioned in a second row. Additionally, the same can also be applied to cases in which three or more rows of seats or a center seat are arranged.

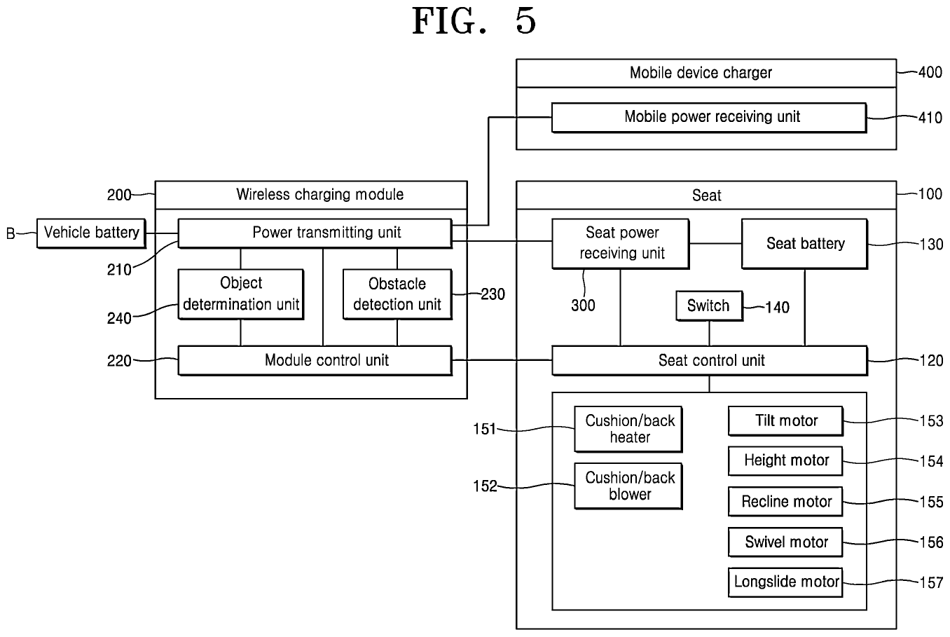

Hereinafter, with reference to FIG. 5, the long range wireless charging system for vehicle 1000 according to one embodiment of the present disclosure will be described in detail.

As shown in FIG. 5, the wireless charging module 200 of the long range wireless charging system for vehicle 1000 according to one embodiment of the present disclosure may include a power transmitting unit 210, a module control unit 220, an obstacle detection unit 230, and an object determination unit 240.

Further, the seat 100 of the long range wireless charging system for vehicle 1000 according to one embodiment of the present disclosure may include a seat control unit 120, a seat battery 130, and a switch 140. The seat 100 of the long range wireless charging system for vehicle 1000 may further include a cushion/back heater 151, a cushion/back blower 152, a tilt motor 153, a height motor 154, a recline motor 155, a swivel motor 156, and a long slide motor 157.

Further, the module control unit 220 detect objects which are positioned on a power supply path of the power transmitting unit 210 and the seat power receiving unit 300 through the obstacle detection unit 230. The obstacle detection unit 230 can judge that an object has been detected when a wireless power signal sent by the power transmitting unit 210 is not received by the seat power receiving unit 300. The obstacle detection unit 230 can also detect objects using a separate infrared sensor.

Further, the module control unit 220 can judge whether the object detected by the obstacle detection unit 230 is a human or a thing through the obstacle detection unit 230. The object determination unit 240 can be applied with various sensors or devices, such as a separate infrared sensor to detect infrared radiation from human body temperature, or a camera.

The module control unit 220 receives remaining battery level information of the seat battery 130 from a seat control unit 120 and judges whether a predetermined reference amount, for example, a charge amount of 80% or more, has been met to select a seat which requires charging. As a result, when a plurality of seats are positioned in a vehicle, charging can be performed on a one-to-one basis according to charging priority. Further, it is also possible prepare a plurality power transmitting units 210 to charge all seats simultaneously, except for a seat which meets the reference amount.

Various types of wireless communication technologies such as Bluetooth, radio frequency, and Wi-Fi can be applied to information communication of the wireless charging module 200 and the seats 100. Considering response speed or interference with external radio waves, communication using Bluetooth is most preferable.

Further, a passenger can activate a heater or blower of the seat cushion or seatback through a switch 140 installed on the seat 100, and automatically tilt, recline, swivel, move forward, move backward, and adjust height of the seat operated by a seat battery.

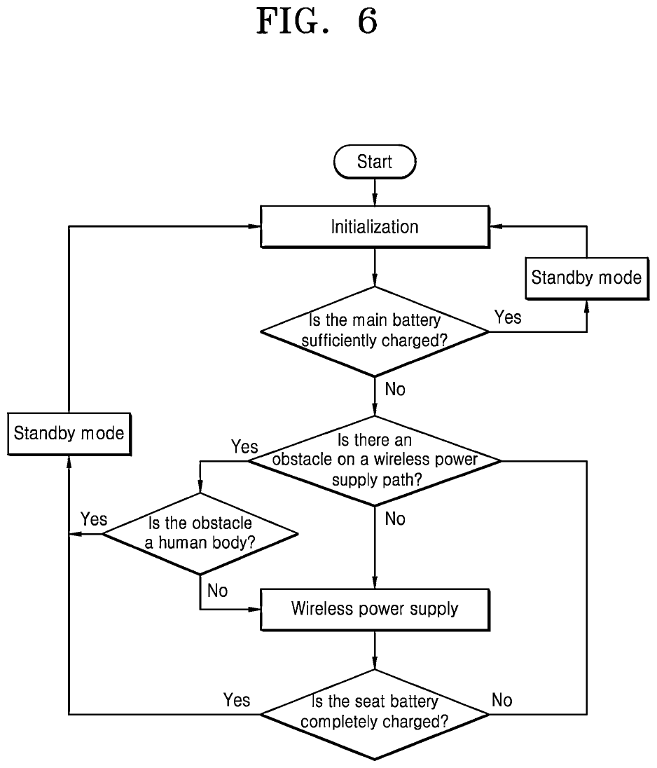

Accordingly, as shown in FIG. 6, the module control unit 220 can interrupt the transmission of the wireless power signal of the power transmitting unit 210 if a detected object is a human body, and can continue the transmission of the wireless power signal of the power transmitting unit 210 if a detected object is a thing. In this specification, the human body may correspond to a companion animal in addition to the human body, and in case of a flammable object, the wireless power signal transmission can be interrupted even if it is not a human body.

Further, the long range wireless charging system for vehicle 1000 according to one embodiment of the present disclosure may include a mobile device charger 400 which receives the wireless power signal from the power transmitting unit 210 so as to transmit the wireless power signal to at least one portable mobile device positioned inside a vehicle.

The mobile device charger 400 may include a mobile power receiving unit 410 which receives power from the power transmitting unit 210 wirelessly, and may also include output terminals such as a 5-pin, an 8-pin, or a Type-C to supply power to cell phones, tablets, laptops and the like.

Thus, in the long range wireless charging system for vehicle 1000 according to one embodiment of the present disclosure, the power transmitting unit 210 of the wireless charging module 200 can be powered by a vehicle battery B to transmit a long range wireless power signal to the seat control unit 120 or the seat battery 130 or the mobile device charger 400, and a passenger can use the switch 140 to control various operations and functions of the seat or freely use various mobile devices while charging them.

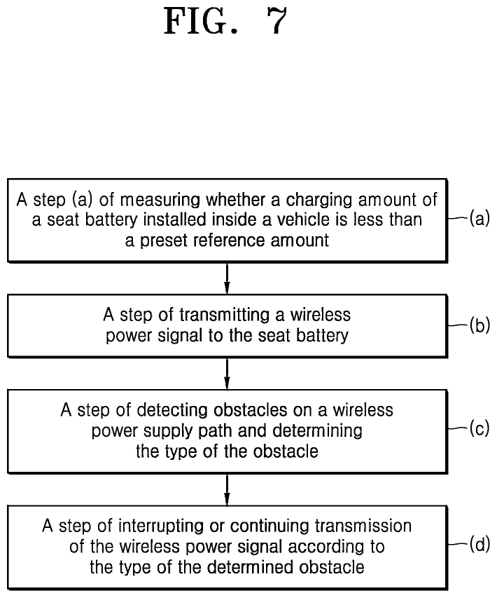

Hereinafter, with reference to FIG. 7, a long rang wireless charging method for vehicle according to one embodiment of the present disclosure will be described.

As shown in FIG. 7, the long range wireless charging method for vehicle may include a step (a) of measuring whether a charging amount of a seat battery installed inside a vehicle is less than a preset reference amount, a step (b) of transmitting a wireless power signal to the seat battery, a step (c) of detecting obstacles on a wireless power supply path and determining the type of the obstacle, and a step (d) of interrupting or continuing transmission of the wireless power signal according to the type of the determined obstacle. The specific details of each step will be omitted as they are the identical to the description of the long range wireless charging system for vehicle.

Therefore, through the long range wireless charging system and method for vehicle according to one embodiment of the present disclosure, seats can be driven freely without wires twisting, and safety of passengers can be ensured by interrupting the power supply when a human body is detected on the power supply path. Further, various mobile devices can be freely used while wirelessly charging from a long distance.

The present disclosure has been described with reference to the embodiments illustrated in the drawings, but these embodiments are merely illustrative and it should be understood by a person with ordinary skill in the art that various modifications and equivalent embodiments can be made without departing from the scope of the present disclosure. Therefore, the true technical protective scope of the present disclosure must be determined based on the technical concept of the appended claims.

What is claimed is:

1. A long range wireless charging system for vehicle comprising:
a wireless charging module comprising a power transmitting unit installed on one side of a vehicle body which transmits a wireless power signal; and
a seat power receiving unit installed on one side of a seat, which receives the wireless power signal from the power transmitting unit.

2. The long range wireless charging system for vehicle of claim 1,
wherein the wireless charging module comprises
a module control unit which applies a charging control signal to the power transmitting unit.

3. The long range wireless charging system for vehicle of claim 2,
wherein the seat power receiving unit is installed on a headrest of the seat to supply power to a seat control unit or a seat battery installed on the seat.

4. The long range wireless charging system for vehicle of claim 3,
wherein the headrest comprises
a central head supporting part comprising at least a portion of a support surface supporting a human head;
a left head supporting part installed on left side of the central head supporting part with respect to a human body seated on the seat, formed to protrude by a predetermined distance in a front direction from the support surface of the central head supporting part; and
a right head supporting part installed on right side of the central head supporting part with respect to a human body seated on the seat, formed to protrude by a distance corresponding to the left head supporting part.

5. The long range wireless charging system for vehicle of claim 4,
wherein the seat power receiving unit comprises at least one power receiving unit among a left power receiving unit installed on the left head supporting part and a right power receiving unit installed on the right head supporting part.

6. The long range wireless charging system for vehicle of claim 5,
wherein the seat is a swivel seat configured to rotate at a predetermined angle to face the front, side, or rear direction of a vehicle, and the module control unit applies a charging control signal to selectively supply wireless power to at least one power receiving unit among the left power receiving unit and the right power receiving unit according to rotation angle of the seat or position of the seat inside a vehicle.

7. The long range wireless charging system for vehicle of claim 2,
wherein the wireless charging module further comprises
an obstacle detection unit which detects an object on a power supply path of the power transmitting unit and the seat power receiving unit, and applies an obstacle detection signal to the module control unit; and
an object determination unit which determines whether the object detected by the obstacle detection unit is a human body by determining the obstacle detection signal.

8. The long range wireless charging system for vehicle of claim 7,
wherein the module control unit applies a power supply interruption control signal to the power transmitting unit when the object detected by the obstacle detection unit is determined to be a human body by the object determination unit.

9. The long range wireless charging system for vehicle of claim 7,
wherein the module control unit applies a wireless power signal to the power transmitting unit when the object detected by the obstacle detection unit is determined to be a thing by the object determination unit.

10. The long range wireless charging system for vehicle of claim 1,
wherein the wireless charging module is installed on a ceiling of a vehicle body and is installed in a position corresponding to a center of an interior space of the vehicle.

11. The long range wireless charging system for vehicle of claim 1, further comprising
a mobile device charger which receives the wireless power signal from the power transmitting unit so as to transmit the wireless power signal to at least one portable mobile device positioned inside a vehicle.

12. The long range wireless charging system for vehicle of claim 1,
wherein the wireless charging module supplies power wirelessly using at least one of infrared wave, ultrasound wave, electromagnetic wave, and laser.

13. The long range wireless charging system for vehicle of claim 3,
wherein the headrest comprises a pair of fixing poles coupled to a backrest of the seat by sliding and having a connector formed on at least a portion thereof to electrically connect with the battery installed on the seat.

14. A long range wireless charging method for vehicle, comprising:
a step (a) of measuring whether a charging amount of a seat battery installed inside a vehicle is less than a preset reference amount;
a step (b) of transmitting a wireless power signal to the seat battery;
a step (c) of detecting obstacles on a wireless power supply path and determining the type of the obstacle; and
a step (d) of interrupting or continuing transmission of the wireless power signal according to the type of the determined obstacle.
